(19) United States
(12) Patent Application Publication
(10) Pub. No.: US 2026/0192772 A1
(43) Pub. Date: Jul. 9, 2026

(54) AIRBAG HAVING AN ACTIVE VENTILATION DEVICE

(71) Applicants: Autoliv Development AB, Vargarda (SE); AUDI AG, Ingolstad (DE)

(72) Inventors: Johann UNGER, Dachau (DE); Marc SCHOCK, Karlsfeld (DE); Thomas REITER, Vierkirchen (DE)

(21) Appl. No.: 19/130,747

(22) PCT Filed: Nov. 15, 2023
(86) PCT No.: PCT/EP2023/081952

§ 371 Date: May 16, 2025

(30) Foreign Application Priority Data
Nov. 22, 2022 (DE) 10 2022 130 858.8

(51) Int. Cl. B60R 21/239

(52) U.S. Cl. CPC B60R 21/239; B60R 2021/2395

(57) ABSTRACT

An airbag with an active ventilation device, where the airbag has a first skin enclosing a first gas space. The device comprises a breakthrough in a first layer of the first skin and a cover element arranged on the outer surface of the first layer covering the breakthrough and being permanently connected to the first layer by a cover element connection, wherein the connection is not closed, thereby forming an opening area between the first layer and the cover element. The device comprises an expansion assembly with a second skin enclosing a second gas space and a gas generator. The second skin is arranged on the inner surface of the first layer and overlaps the cover element at least in sections. A portion of a tear seam of the extends through the cover element, the first layer and the second skin and prevents or restricts gas escape.

The invention relates to an airbag with an active ventilation device according to claim 1 and to an airbag unit with such an airbag and a main inflator according to claim 12.

Every airbag which serves to protect a vehicle occupant in the event of an accident has an outer skin (hereinafter also referred to as the first skin) which encloses a first gas space. This first skin has at least one first layer which has an inner surface facing the first gas space and an outer surface facing away from the first gas space.

It is known to equip such an airbag with an active ventilation device which has a throttled or closed first state and an open second state. Here, the first layer has a breakthrough through which gas can escape at least in the second state.

Such an airbag with a ventilation device is known from generic DE 10 2012 016 460 B4. Here, a sleeve extending around the breakthrough and being connected to the first skin is provided from which a pull element extends. The end of this pull element facing away from the sleeve is connected via a tear seam to a second skin (“microbag”) which can be filled by a gas generator in such a way that the tear seam tears. The second skin and the associated gas generator form an expansion assembly. If the first skin is fully inflated but the second skin is not, the pull element is under tensile stress and holds the sleeve inside the first gas space in a tensioned state so that the ventilation device is in a throttled first state. When the gas generator is ignited, the second skin expands and the tear seam ruptures. This releases the second end of the pull element, the sleeve is pushed outwards by the gas pressure in the first gas space, and the ventilation device is in its open second state.

A disadvantage of this prior art is that there is a certain time delay between the activation of the gas generator of the expansion assembly and the complete attainment of the second state, since the sleeve must first turn outward.

Based on this, the present invention aims to provide an airbag with an alternatively designed ventilation device in which, in particular, a very short time delay between the ignition of the gas generator of the expansion assembly and the complete attainment of the second state can be achieved.

This task is solved by an airbag with the features of claim 1. An airbag unit with such an airbag and a main inflator is specified in claim 12.

The airbag according to the invention has a cover element arranged on the outer surface of the first layer and firmly connected to the first layer which covers the breakthrough at least in sections, preferably completely. The connection between the first layer and the cover element is made by means of a cover element connection which is not closed, so that an opening area is formed between the first layer and the cover element. The cover element connection can be designed in particular in a U-shape for this purpose.

As in the airbag of the generic DE 10 2012 016 460 B4, an expansion assembly comprising a second skin enclosing a second gas space and a gas generator is provided. However, this expansion assembly is not used for holding and releasing a pull element, but directly influences the state of the breakthrough and the state of the cover element. For this purpose, the second skin is arranged on the inside of the first layer and overlaps the cover element at least in sections, in particular in the opening area. The airbag according to the invention also comprises a tear seam. This has a section which extends through the cover element, the first layer and the second skin. The tear seam blocks gas escape through the opening area at least partially, preferably completely, and holds the ventilation device in its first state, in which it can in particular be completely sealed.

When the gas generator is ignited, the tear seam ruptures due to the expanding second skin and the opening area is released, so that gas from the first gas space can flow through the breakthrough into the area between the first layer and the cover element and escape from there through the now open opening area.

The ventilation device according to the invention has in particular the following advantages: Due to the arrangement of the second skin and the tear seam, the time delay between activation of the gas generator and reaching the second state is very short. This also means that the ventilation device has practically no undefined intermediate state between the first state and the second state, resulting in very reproducible behavior. Finally, both, a completely closed first state and a second state with a large opening cross-section, i.e., strong ventilation, can be achieved.

Preferably, the breakthrough has at least one slit-shaped section or is designed to be slit-shaped overall. By this measure, the pressure acting between the first layer and the cover element in the first state can be kept low and the cover element can be relieved. A slit is a structure, in which the opposite edges touch or at least almost touch, i.e., essentially no material is “missing” between the opposite edges. Significant gas passage can only occur when the slit gapes which distinguishes a slit significantly from an elongated hole.

In order to increase the free cross-section in the second state, it can be preferred that the cover element is folded in the first state and is at least three-layered at least in sections. In the second state, the cover element unfolds so that the free cross-section between the cover element and the first layer increases, at least in the opening area.

In a first preferred embodiment, the first (outer) skin of the airbag further has a second layer and the ventilation device is arranged in an area of an edge of the first layer, i.e. where the two layers meet. Additionally, the breakthrough extends to the edge of the first layer and the first layer is permanently connected to the second layer along its edge by means of an edge connection, wherein at least the area of the ventilation device in which the breakthrough ends at the edge, preferably the entire opening area, is free of a permanent connection. The tear seam crosses the breakthrough. An airbag of this type is easy to manufacture and, in particular when the breakthrough is slit-shaped, allows a large ventilation cross-section in the second state.

In the embodiment described above, it is generally advantageous for the gas generator of the expansion assembly to be arranged outside the first gas space. It is therefore preferable that a section of the second skin protrudes from the edge of the first skin so that this section is located outside the first gas space. To simplify assembly, the second layer may have a bulge located outside the first gas space such that the section of the second skin and the bulge overlap at least in sections.

Also to simplify assembly, the second skin may be connected to the second layer by means of an assembly connection which connects only the second skin and the second layer of the first skin.

In a second preferred embodiment, the ventilation device is located in an area of the first layer spaced from the edge, and the second layer is not involved in the ventilation device. In this case, it is particularly advantageous to design the breakthrough in the first layer in a T- V- or U-shape.

In order not to impede the expansion of the second skin, it is preferable that only the tear seam extends through the second gas space.

Preferably, at least one layer of the second skin is gas-permeable so that, after expansion of the second skin and the resulting at least partial tearing of the tear seam, the gas can escape from the second skin. This prevents the expanded second skin from obstructing the venting in the second state of the ventilation device. The gas permeability can be achieved, for example, by micro perforation.

The invention is now described in more detail with reference to preferred embodiments in view to the figures. The figures show:

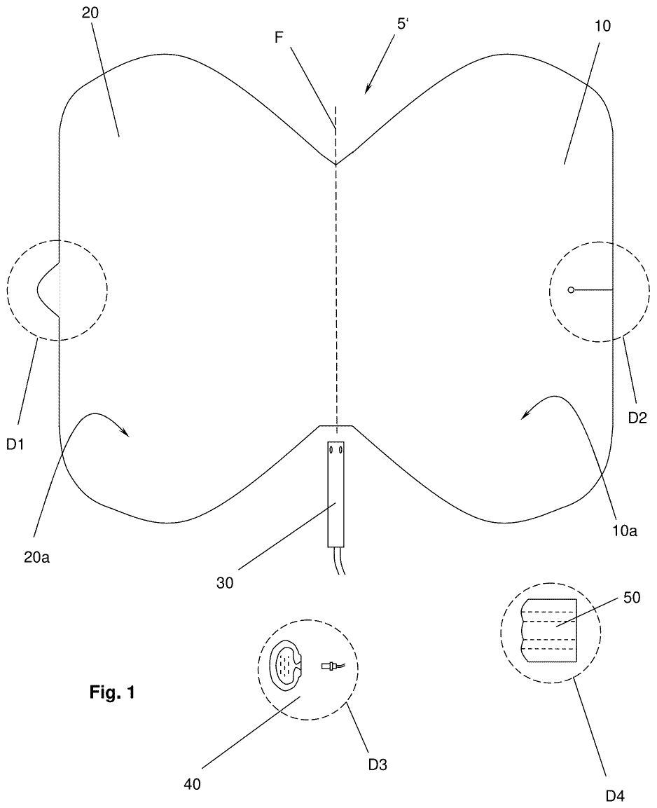

FIG. 1: all components (except seams) of a first embodiment of an airbag unit in a schematic representation,

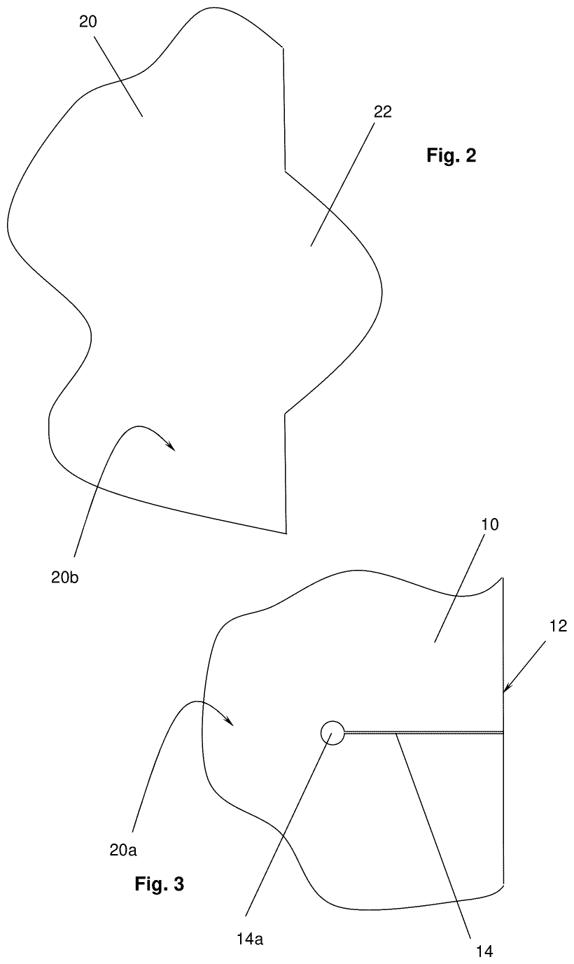

FIG. 2 the detail D1 from FIG. 1 in an enlarged representation, but in a view from the rear relative to FIG. 1,

FIG. 3 the detail D2 from FIG. 1,

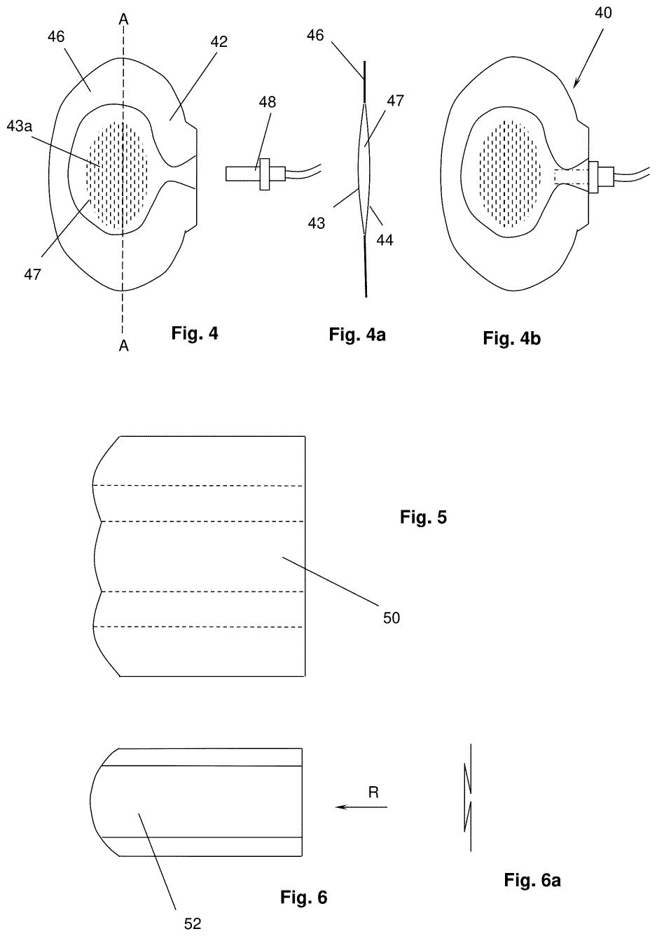

FIG. 4 the detail D3 from FIG. 1, namely a second skin and a gas generator

FIG. 4a a section along plane A-A in FIG. 4,

FIG. 4b an expansion assembly consisting of the second skin and the gas generator of FIG. 4,

FIG. 5 the detail D4 from FIG. 1, namely the cutting for a cover element,

FIG. 6 the cover element folded from the cutting of FIG. 5,

FIG. 6 a a side view of the cover element of FIG. 6 from direction R in FIG. 6,

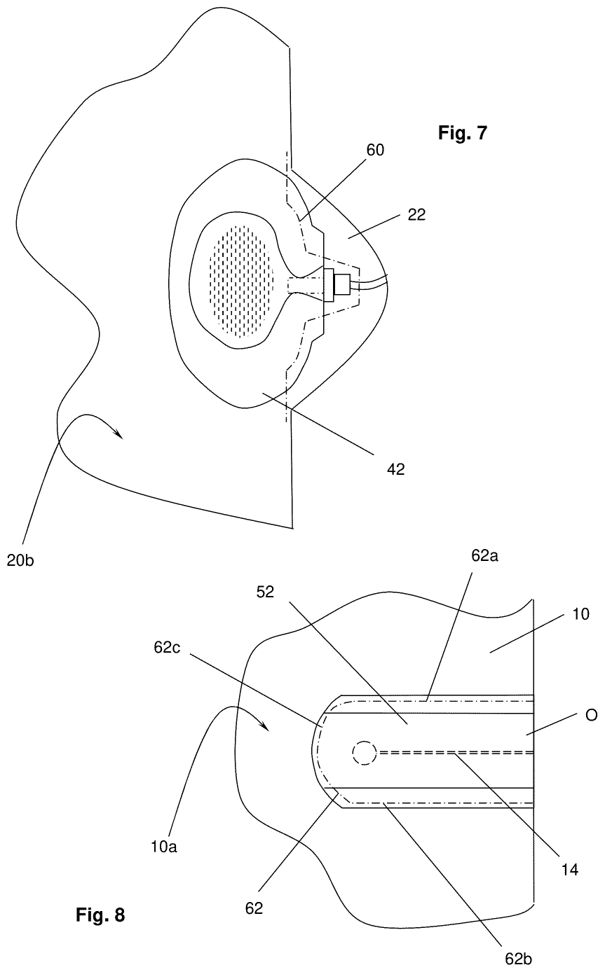

FIG. 7 the section of the second layer of the first skin shown in FIG. 2 and the expansion assembly shown in FIG. 4b which is attached to the first skin by means of an assembly seam,

FIG. 8 the section of the first layer of the first skin shown in FIG. 3 and the folded cover element shown in FIG. 6, which is attached to the first skin by means of a cover element seam,

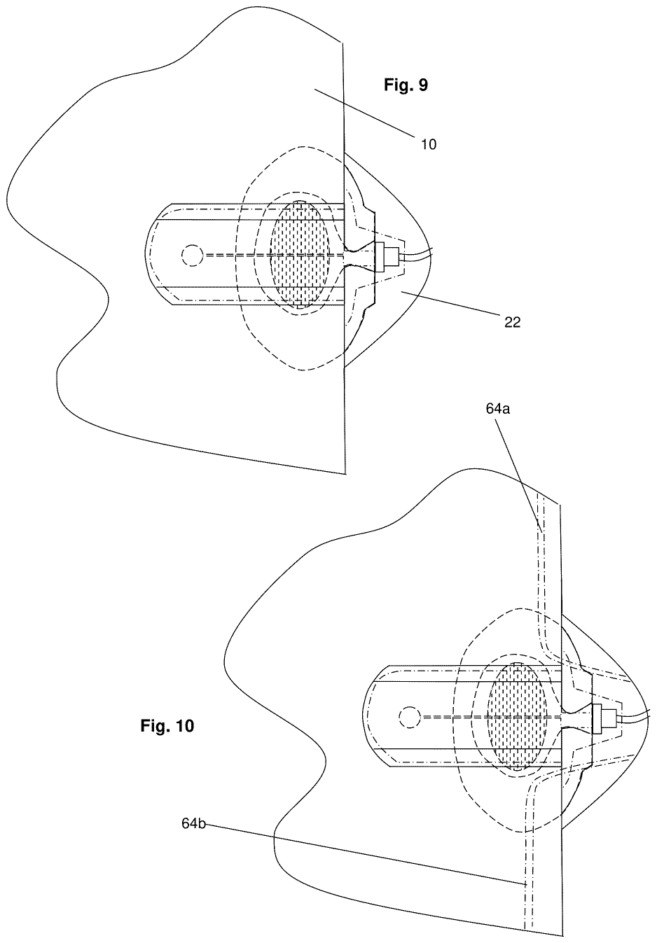

FIG. 9 the items shown in FIG. 7 and the items shown in FIG. 8, after folding the first skin along its folding line,

FIG. 10 the items shown in FIG. 9 after attaching sections of the edge seam,

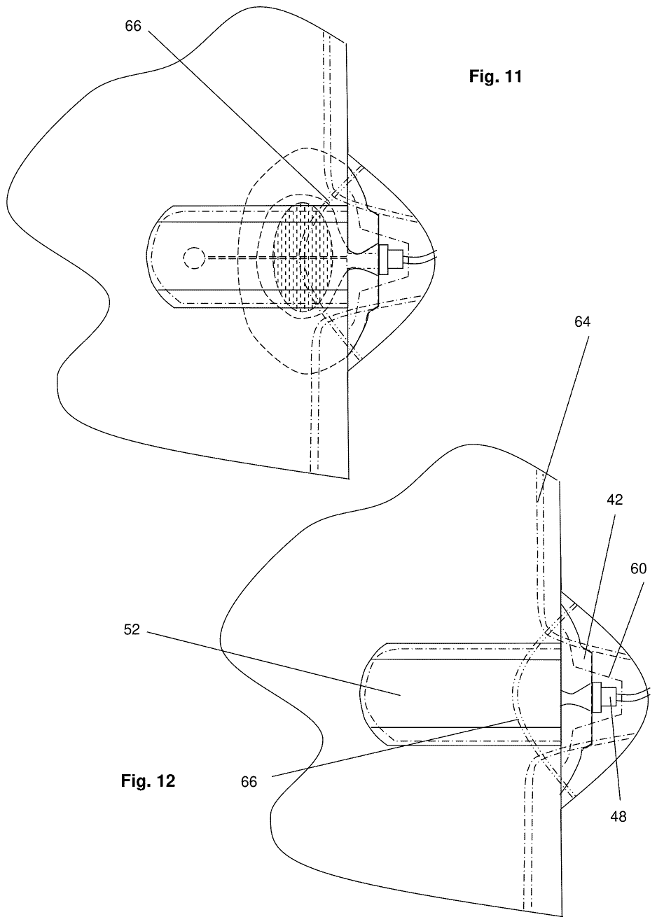

FIG. 11 the items shown in FIG. 10 after attaching a tear seam,

FIG. 12 the items shown in FIG. 11, with concealed elements not being shown,

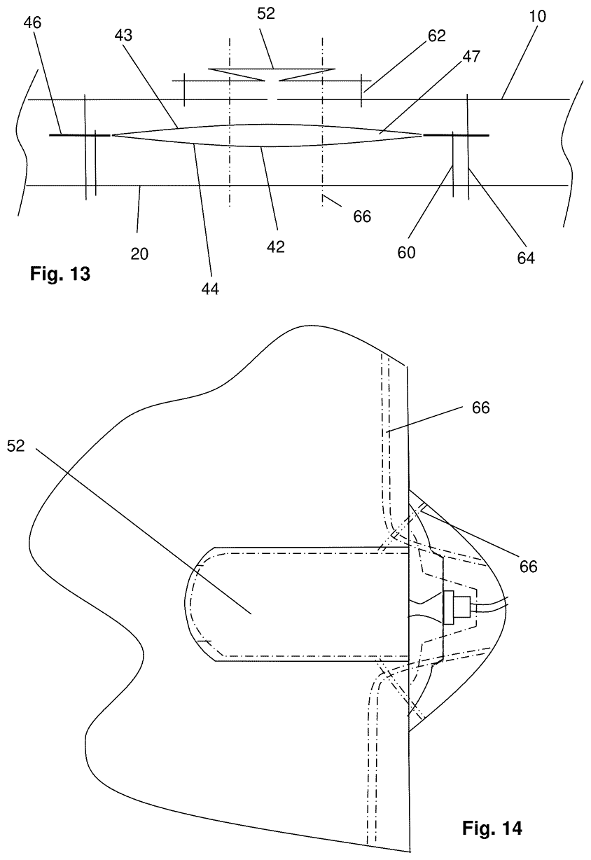

FIG. 13 a highly schematic representation of the layer structure of the ventilation device,

FIG. 14 the ventilation device in an arrangement corresponding to FIG. 12 after actuation of the gas generator of the expansion assembly,

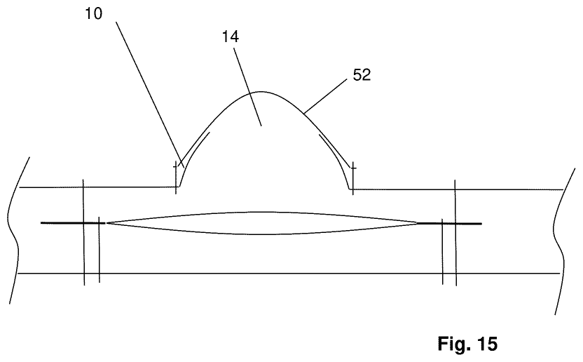

FIG. 15 the items shown in FIG. 13 in the state after actuation of the gas generator (corresponding to the state shown in FIG. 14),

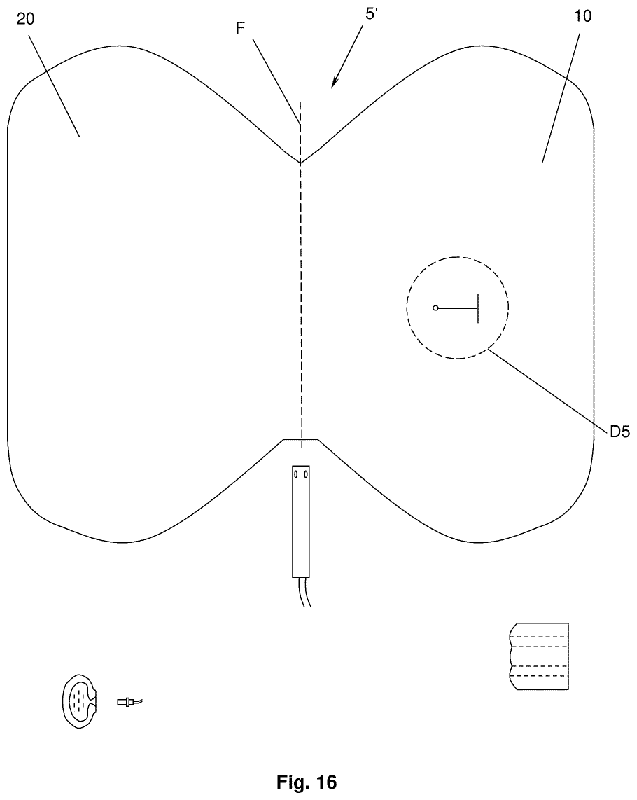

FIG. 16 all components (except seams) of a second embodiment of an airbag unit in a schematic representation,

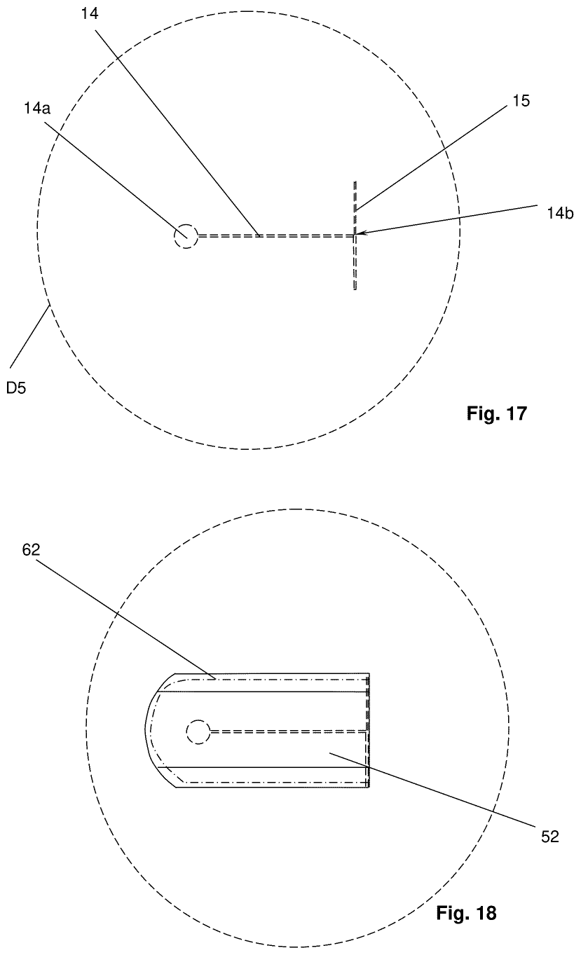

FIG. 17 the detail D5 from FIG. 16,

FIG. 18 the section of the first layer of the first skin shown in FIG. 17 and the folded cover element shown in FIG. 6 which is fastened to the outer surface of the first skin by means of a cover element seam,

FIG. 19 the items shown in FIG. 18 and the expansion assembly arranged on the inner surface of the first layer of the first skin,

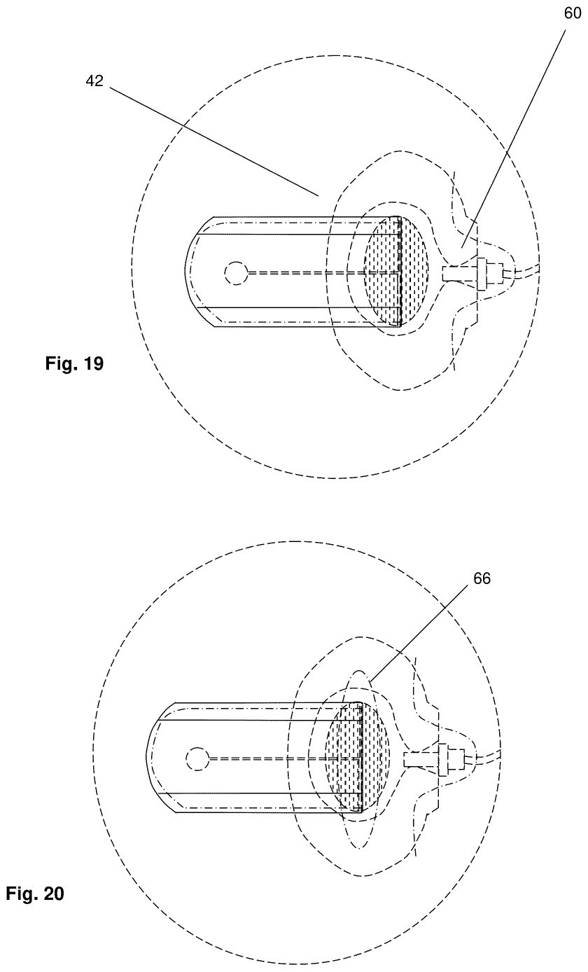

FIG. 20 the items shown in FIG. 19 after the tear seam has been applied,

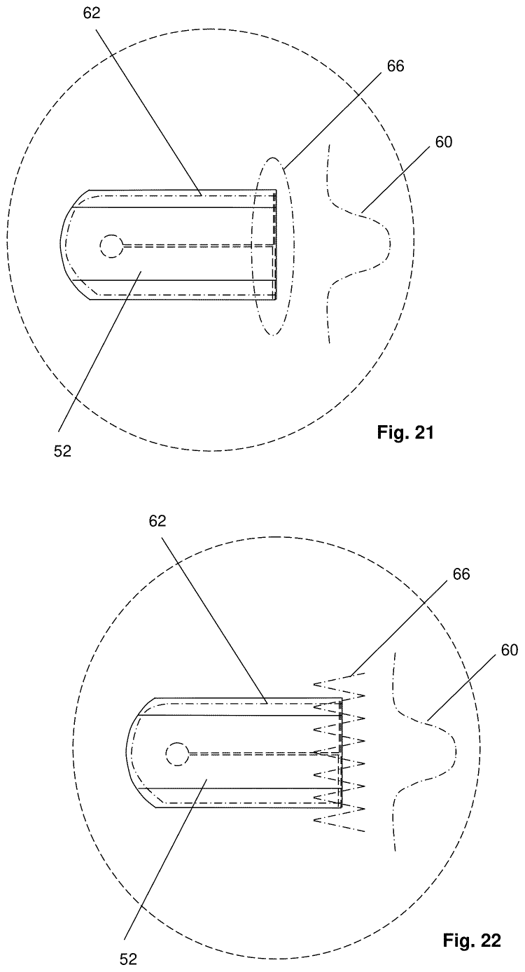

FIG. 21 the items shown in FIG. 20, but with concealed elements not being shown,

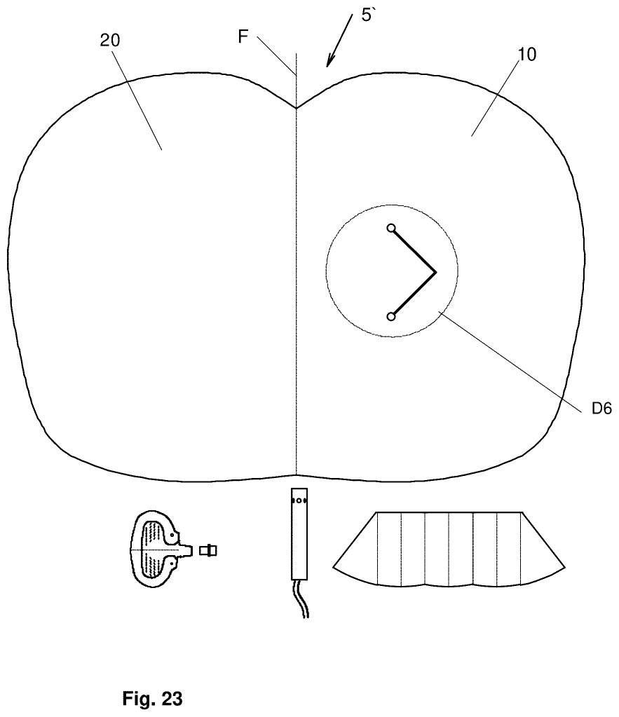

FIG. 22 an alternative design of the tear seam in a representation according to FIG. 21,

FIG. 23 all components (except seams) of a variation of the second embodiment of an airbag unit in a schematic representation according to FIG. 16,

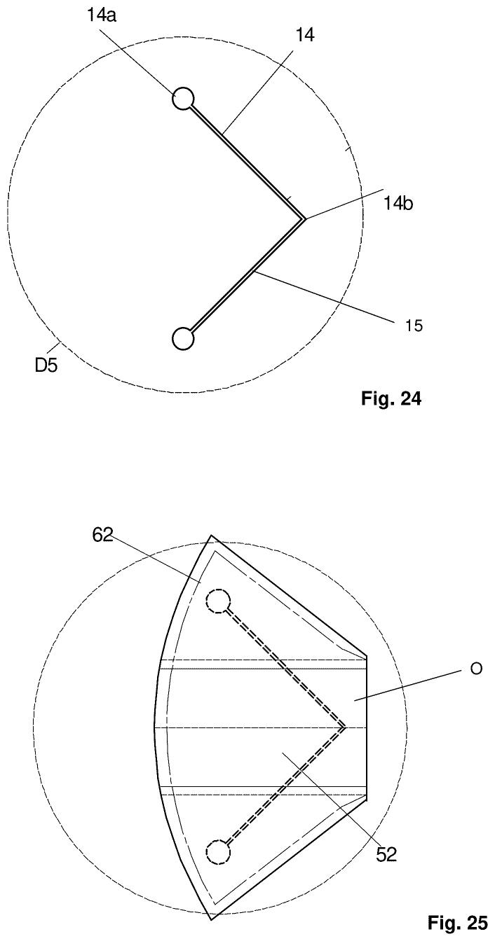

FIG. 24 the detail D6 from FIG. 23,

FIG. 25 the detail shown in FIG. 24 and the cover element shown in FIG. 23 which is sewn to the first layer in the folded state and covers the breakthrough (corresponding to FIG. 8),

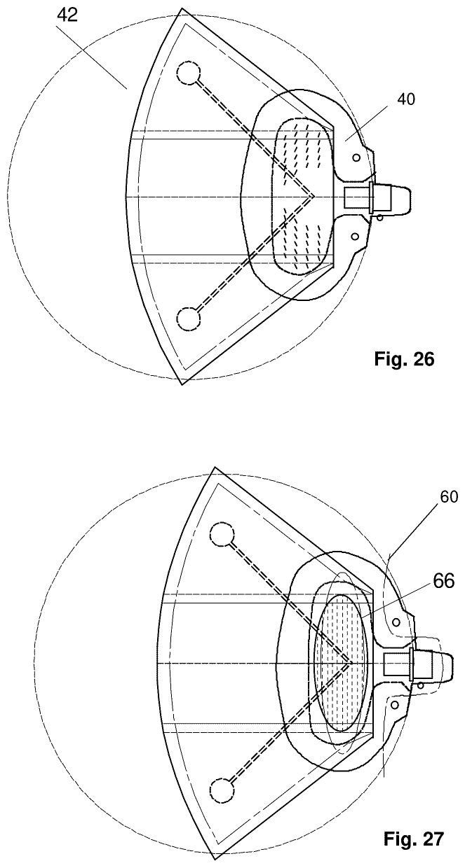

FIG. 26 the detail shown in FIG. 25 and the expansion assembly being arranged on the inner surface of the first layer,

FIG. 27 the items shown in FIG. 26 after the assembly seam and the tear seam have been applied (corresponding to FIG. 20),

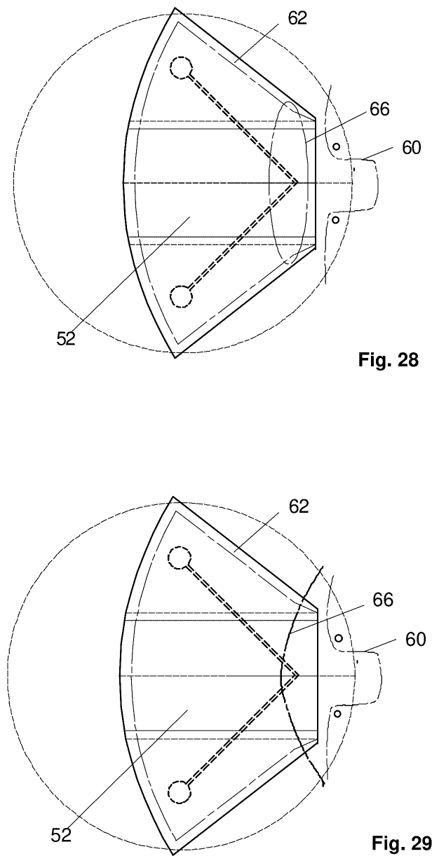

FIG. 28 the arrangement shown in FIG. 27, but without showing the expansion assembly, and

FIG. 29 the arrangement shown in FIG. 28 with an alternative design of the tear seam.

The invention is now described with by means to examples of an airbag unit. This airbag unit has an airbag and a main inflator. In the example described, the airbag is a side airbag with a simple basic structure whose outer skin (hereinafter referred to as the first skin) has only two layers (so-called 2D-airbag). However, this is only to be understood as an example. The invention can in principle be applied to any airbags or airbag units. The only essential feature is that the airbag has an actively controllable ventilation device.

In order to better understand the structure of the airbag according to the invention, in particular its ventilation device, the manufacture of the airbag from its components is first described. Only the components that are absolutely necessary for this embodiment of the invention are shown and described, but of course an airbag according to the invention may have further components (such as inner or outer tethers or the like). However, in order to keep the description simple, such further (optional) components are not shown or described.

FIG. 1 shows all components of a side airbag unit according to the invention, i.e., the components of the airbag (except for connections, in particular seams) and the main inflator 30. Like every airbag, the airbag has a first skin (which could also be referred to as an outer skin) which surrounds a first gas space. The main inflator 30 is used to fill this first gas space.

In the embodiment shown, the first skin (outer skin) has two layers 10, 20, which are produced from a joint cutting 5′ by folding along the folding line F (so-called butterfly design). However, this is not essential for the invention. The two layers could also be made from separate cuttings.

In the example embodiment of the first embodiment shown, the ventilation device is located in an edge area where the two layers are connected to each other. It would be possible to arrange the ventilation device away from such an edge area, but this is not generally preferred.

With this in mind, the components shown in FIG. 1 are now described:

The joint cutting 5′ of the first skin has a first section for the first layer 10 and a second section for the second layer 20. These two sections are folded onto each other along the folding line F to form the first skin, as is of course known in the prior art. As mentioned, originally separate cuttings for the two layers could also be provided. The first layer 10 has (naturally) an outer surface 10a and an inner surface 10b. Inner surface means in this connection that, when the airbag is fully assembled, this inner surface 10b faces at least in sections toward the first gas space, which is enclosed by the outer skin. The same applies, of course, to the second layer 20, which has an inner surface 20b facing the gas space at least in sections and an outer surface 20a. In the state of the first skin shown in FIG. 1, the outer surfaces 10a, 20a of the two layers 10, 20 are visible.

In the region of an edge (in the embodiment shown, in the region of the edge opposite the folding line F), the first layer 10 has a slit-shaped breakthrough 14 which extends to the edge (detail D2—FIG. 3). The first end (inner end) 14a of the slit-shaped breakthrough 14 facing away from the edge is widened and is essentially circular in shape. Opposite the area of the first layer 10 just described, the second layer 20 has a bulge 22 in the edge area (detail D 1-FIG. 2). The slit 14 and the bulge 22 are components of the active ventilation device according to the invention.

FIG. 1 also shows the components of an expansion assembly 40 (detail D3 FIG. 4) and a cutting 50 of a cover element (detail D4—FIG. 5) which are essential components of the ventilation device and which are now described in more detail with reference to FIGS. 4 to 4b and 5 to 6a, respectively:

FIG. 4 shows the detail D3 of FIG. 1, namely the components of an expansion assembly. These are a second skin 42, which encloses a second gas space 47, and an associated gas generator 48 for filling this second gas space. Such an expansion element 40 is described in detail, for example, in WO 2014/029 473 A1. The second skin 42 (often referred to as a “microbag”) has a first layer 43 and a second layer 44 in the area of the second gas space 47, and these two layers are connected to each other in an edge area 46 (see in particular FIG. 4a). The second skin 42 is preferably manufactured in a one-piece woven process. Furthermore, at least one of the two layers of the second skin, here the first layer 43, preferably has a gas-permeable ventilation area 43a so that gas can escape from the second gas space 47 after it has been filled. The edge area 46 is preferably relatively wide since, as will be seen later, seams are arranged which extend through this edge area 46 but not through the second gas space 47.

As is known in the prior art, the gas generator 48 protrudes through an opening in the second skin into the latter (FIG. 4b) so that it fills the second gas space upon ignition. The gas generator is usually in the form of a pyrotechnic ignition element (“squib”).

FIG. 5 shows the detail D4 from FIG. 1, namely the cutting 50 of a cover element of the ventilation device. In FIG. 5, dotted folding lines are drawn along which the cutting 50 is folded to form the folded cover element 52 (see FIGS. 6 and 6a). Due to the folding, the folded cover element 52 is in sections at least three layered (FIG. 6a).

The installation of the airbag 5 is now described. The main inflator is usually positioned on or in the first skin once the assembly of the airbag has been completely finished. This is not shown here.

As shown in FIG. 7, in one assembly step, the expansion assembly 40—namely its second skin 42—is fastened to the inner surface 20b of the second layer 20 in the area of the bulge 22 by means of an assembly seam 60. The assembly seam 60 extends exclusively through the edge region 46 of the second skin, not through the second gas space 47. This assembly seam primarily serves as a preliminary fixation and could be replaced by an alternative connection technique, such as gluing.

The folded cover element 52 is arranged on the outer surface 10a of the first layer 10 in such a way that the slit-shaped breakthrough 14 is completely covered and an edge region of the folded cover element 52 is flush with the edge region of the first layer 10 at which the slit-shaped breakthrough 14 ends. The U-shaped cover element seam 62 which serves as a cover element connection is used for fastening. The side legs 62a, 62b of the U extend outward from the folding lines and the transverse leg 63c of the U extends, of course, across the entire width of the folded cover element. Thus, the cover element is held in its folded form by the cover element seam (namely by the transverse leg 63c), but can still unfold. In the area of the edge, the cover element is not connected to the first layer by the cover element seam 63, resulting in an opening area O.

In the next production step (see FIG. 9), the cutting 5′ of the first skin 5 is folded along the folding line so that the first layer 10 and the second layer 20 lie on top of each other. As a result, the slit-shaped breakthrough 14 now lies in sections on the expansion element 40.

In the next step, an edge seam 64 is applied as an edge connection which connects the edges of the two layers 10, 20 to each other and thus (in the embodiment shown, together with the folding line F) encloses the first gas space. It is important that the edge seam does not cross the breakthrough 14 and does not close the opening area O, which is achieved in the embodiment shown by the edge seam 64 having two sections 64a and 64b which also extend through the edge area 46 of the second skin. Furthermore, the edge seam 64 should not run through the second gas space 47. The condition after attachment of the edge seam 64 is shown in FIG. 10.

In the final step (FIG. 11), a tear seam 66 is arranged, which cuts through the two sections 64a and 64b of the edge seam and the two side legs 62a, 62b of the cover element seam 62 and thereby closes the opening area O so that gas cannot flow from the first gas space through the space between the first layer and the cover element through the opening area. The tear seam 66 also extends through the second gas space 47.

This results in a layer structure, which is shown schematically in FIG. 13: Between the first layer 10 and the second layer 20 the second skin 42 is located which is also double-layered in sections and on the outer surface 10a of the first layer 10 the cover element 52 is located which is triple-layered in sections. It is essential to note which layers the seams described above extend through: Only the tear seam 66 extends through all layers and also crosses the second gas space 47. The cover element seam 62 connects only the outer edge of the cover element 52 to the first layer 10, whereby it should be noted (this is not shown in FIG. 13) that the transverse leg 62c of the U-shaped cover element seam 62 extends through all layers of the cover element. The sections of the edge seam 64 extend through both layers 10, 20 and the edge area 46 of the second skin 42. The assembly seam connects the edge area of the second skin 42 with the second layer 20.

When the gas generator is ignited, the second skin 42 expands and the tear seam is destroyed in the area of the second skin 42. This releases the opening area O, the originally slit-shaped breakthrough 14 gapes open, the cover element 52 bulges out, and gas can flow out of the first gas space through this breakthrough and the opening area (FIGS. 14 and 15).

FIGS. 16 to 21 show an example embodiment of a second embodiment of the invention. The difference to the first embodiment is that the active ventilation device is not located in an edge region of the first layer and, in particular, does not extend to the edge.

As can be seen from FIG. 16, the second embodiment consists of the same components as the first embodiment, except that the breakthrough in the first layer is designed and positioned differently, as can be seen, for example, in FIGS. 16 and 17:

As in the first embodiment, the breakthrough has a first slit-shaped section 14 extending from a first end 14a. However, this first slit-shaped section 14 does not extend to the edge, but ends at a second end 14b. From there, a second slit-shaped section 15 extends, preferably vertically, so that the breakthrough is T-shaped. The second slit-shaped section “replaces” (with regard to the ventilation device) the open edge area of the first embodiment.

As can be seen in FIG. 18, as in the first embodiment, the folded cover element 52 is first arranged on the outer surface 10 of the first layer 10 by means of the cover element seam 62 in such a way that it covers the first slit-shaped section 14. The front end of the cover element 52 is essentially aligned with the second slit-shaped section 15 of the breakthrough.

Now, the expansion assembly 40 is arranged on the inner surface of the first layer 10, whereby its second skin 42 can be fastened to the first layer by means of a mounting seam 60. In relation to the first embodiment, the inflator-side end of the expansion assembly is further away from the breakthrough (moved to the right in the selected illustrations).

Finally, the tear seam 66 is arranged which (as in the first embodiment) extends through the first slit-shaped section 14. Due to the absence of the edge seam in the area of the ventilation device, the tear seam 66 completely surrounds the second slit-shaped section 15 and is located within the second skin 42 in order to separate the second slit-shaped section 15 from the first gas space. FIG. 22 shows an alternative design of the tear seam 66 which is designed here as a zig-zag seam and to which the second slit-shaped section 15 is directly sewn.

In the second embodiment, the second layer of the first skin is not involved in the ventilation device, so that the folding of the joint cutting and the arrangement of the edge seam take place after the ventilation device has been produced.

FIGS. 23 to 29 show a variation on the second embodiment. The differences lie in the shape of the breakthrough and in the shape and number of folds of the cover element 52. As can be seen, for example, in FIG. 24, the breakthrough has also two slit-shaped sections 14 and 15, but these do not form a T-shape, but rather a V-shape which also allows a gaping. In this context, it should be mentioned that other shapes of the breakthrough would of course also be possible, for example a U-shape.

As can be seen from FIG. 25, the cover element 52 follows the V-shape of the breakthrough by reducing its width towards the tip of the V (i.e. towards the opening area O). As can be seen in FIG. 27, the assembly seam 60 and the tear seam can be designed as in the embodiment of FIG. 20. FIG. 29 shows a variant of this.

The mode of operation is the same as in the first embodiment.

The embodiments described above illustrate all the advantages of the ventilation device according to the invention: it is simple to manufacture and, when the gas generator is activated, it changes from its first state to its second state almost instantaneously. Furthermore, a completely sealed first state and a highly ventilated second state can be realized.

### LIST OF REFERENCE SIGNS

5 first skin
5′ joint cutting of the first skin
10 first layer
10a outer surface of the first layer
10b inner surface of the first layer
12 outer layer of the first layer (correct: outer edge of the first layer)
14 slit-shaped breakthrough in the first layer/first slit-shaped section of the
breakthrough in the first layer
14a inner end of the slit-shaped breakthrough/first end of the first slit-shaped
section
14b second end of the first slit-shaped section
15 second slit-shaped section of the breakthrough
20 second layer
20a outer surface of the second layer
20b inner surface of the second layer
22 bulge of the second layer
30 main inflator
40 expansion assembly
42 second skin
43 first layer of the second skin
43a ventilation area
44 second layer of the second skin
46 edge area of the second skin
47 second gas space
48 gas generator of the expansion element
50 cutting of the cover element
52 cover element
60 assembly seam
62 cover element seam
64 edge seam
66 tear seam
F folding line
O opening area

1-12. (canceled)

13. An airbag comprising:
a first skin which encloses a first gas space and which has a first layer which has an inner surface facing the first gas space and an outer surface facing away from the first gas space, and
an active ventilation device which has a throttled or closed first state and an open second state and which comprises:
a breakthrough in the first layer,
a cover element arranged on the outer surface of the first layer which covers the breakthrough at least in sections and which is permanently connected to the first layer by means of a cover element connection, wherein the cover element connection is not closed, so that an opening area is formed between the first layer and the cover element,
an expansion assembly comprising a second skin enclosing a second gas space and a gas generator, wherein the second skin is arranged on the inner surface of the first layer and overlaps the cover element at least in sections,
a tear seam which has a section extending through the cover element, the first layer and the second skin and thus prevents or restricts gas escape through the opening area in the first state of the ventilation device.

14. The airbag of claim 13, wherein the breakthrough has at least one slit-shaped section.

15. The airbag of claim 13, wherein the cover element is folded and is at least in sections formed at least three-layered.

16. The airbag of claim 13, wherein
the first skin further comprises a second layer,
the ventilation device is arranged in a region of an edge of the first layer,
the breakthrough extends to the edge of the first layer,
the first layer is permanently connected to the second layer along its edge by means of an edge connection, wherein at least the region of the ventilation device in which the breakthrough ends at the edge is free of a permanent connection.

17. The airbag of claim 16, wherein a section of the second skin protrudes from the edge of the first skin so that this section is located outside the first gas space.

18. The airbag of claim 17, wherein the second layer has a bulge and that the section of the second skin located outside the first gas space and the bulge overlap at least in sections.

19. The airbag of claim 16, wherein the second skin is connected to the second layer by means of a mounting connection which connects only the second skin and the second layer.

20. The airbag of claim 13, wherein the ventilation device is spaced from the edge of the first layer.

21. The airbag of claim 20, wherein the cover element is folded and is at least in sections formed at least three-layered and the breakthrough is T-shaped or V-shaped with two slit-shaped sections, or U-shaped.

22. The airbag of claim 13, wherein only the tear seam extends through the second gas space.

23. The airbag of claim 13, wherein at least one layer of the second skin is gas-permeable at least in sections.

24. An airbag unit consisting of an airbag comprising:
a first skin which encloses a first gas space and which has a first layer which has an inner surface facing the first gas space and an outer surface facing away from the first gas space, and
an active ventilation device which has a throttled or closed first state and an open second state and which comprises:
a breakthrough in the first layer,
a cover element arranged on the outer surface of the first layer which covers the breakthrough at least in sections and which is permanently connected to the first layer by means of a cover element connection, wherein the cover element connection is not closed, so that an opening area is formed between the first layer and the cover element,
an expansion assembly comprising a second skin enclosing a second gas space and a gas generator, wherein the second skin is arranged on the inner surface of the first layer and overlaps the cover element at least in sections,
a tear seam which has a section extending through the cover element, the first layer and the second skin and thus prevents or restricts gas escape through the opening area in the first state of the ventilation device,
and a main inflator for filling the first gas space.
